(19) United States
(12) Patent Application Publication
(10) Pub. No.: US 2012/0096794 A1
(43) Pub. Date: Apr. 26, 2012

(54) FLOOR OR SURFACE COVERING FOR FURNITURE

(76) Inventor: Andreia Kelley, Joppa, MD (US)

(21) Appl. No.: 12/911,692

(22) Filed: Oct. 25, 2010

(51) Int. Cl. E04F 15/00; B32B 3/02

(52) U.S. Cl. 52/311.2; 428/85

(57) ABSTRACT

A floor or surface covering comprising a single article of a material or multiple pieces of a material joined together that form a single article, in which the floor or surface covering surrounds a moveable or fixed article of furniture, in which the floor or surface covering surrounds the movable or fixed article of furniture on two or three sides of the furniture, and in which the floor or surface covering is positioned in a location that is adjacent to the two or three sides of the furniture.

### BACKGROUND OF THE INVENTION

The disclosure generally relates to a floor or surface covering that is formed of a single article of a material or multiple pieces of a material joined together that form a single article. In particular, the floor or surface covering is positioned in a location that is adjacent to two or three sides of an article of furniture. In addition, the disclosure relates to a carpet that is positioned in a location that is adjacent to two or three sides of an article of furniture.

Current designs for floor or surface coverings normally require moving furniture for installation. In particular, installing and removing floor or surface coverings, such as area carpeting, typically require heaving lifting or specialized equipment for installation and removal. Further, traditional small floor coverings are merely used over existing floor or surface areas for covering stains or worn areas, and do not surround furniture, especially large pieces of furniture.

By contrast, the floor of surface covering of the present disclosure is not limited to small areas and one does not have to lift heavy furniture to produce the effects of area carpeting. With very little labor, one only has to place the floor or surface covering around a bed, sofa, or chair without lifting. The floor or surface covering can be installed by a professional or a do-it-yourself decorator.

In particular, the floor or surface covering lays on any type of flooring and around all major bed sizes (twin, full, queen, king, California king), as well as other pieces of furniture, such as chairs, sofas, and love seats. In addition, one can now change carpet colors more frequently.

Further, it can transform an area quickly, making it easy to decorate, and allow one to constantly change the color scheme in an area without the labor associated with area rug replacement. In other words, versatility can be added and waste material subtracted to a floor or surface area, while comfort and style can be maintained.

### BRIEF SUMMARY OF THE INVENTION

In accordance with the disclosure, the floor or surface covering surrounds a moveable or fixed article of furniture, wherein the floor covering surrounds the movable or fixed article of furniture on two or three sides of the furniture, wherein the floor covering is positioned in a location that is adjacent to the two or three sides of the furniture, and wherein the floor covering is a single article of material or multiple pieces of a material joined together that form a single article.

In another aspect of the disclosure, the floor or surface covering is a carpet comprising a single article of material or multiple pieces of a material joined together that form a single article of material, wherein carpet surrounds a moveable or fixed article of furniture on a floor surface, wherein the carpet surrounds the movable or fixed article of furniture on two or three sides of the furniture, and wherein the carpet is positioned in a location that is adjacent to the two or three sides of the furniture.

Other objects will be apparent from the following description of the drawings and embodiments of the invention.

### BRIEF DESCRIPTION OF THE DRAWINGS

FIG. 1 is a plain view of the floor or surface covering surrounding a king size bed;

FIG. 2 is a plain view of the floor or surface covering surrounding a twin size bed;

FIG. 3 is a plain view of the floor or surface covering surrounding a queen size bed;

FIG. 4 is a plain view of the floor or surface covering surrounding a sofa;

FIG. 5 is a plain view of the floor or surface covering surrounding a love seat;

FIG. 6 is a plain view of the floor or surface covering surrounding a full size bed; and

FIG. 7 is a plain view of the floor or surface covering surrounding a mid-size or large chair.

### DETAILED DESCRIPTION OF THE INVENTION

A more complete appreciation of the disclosure and many of the attendant advantages will be readily obtained, as the same becomes better understood by reference to the following detailed description when considered in connection with the accompanying drawings.

The term furniture generally relates to and is understood to include beds, sofas, chairs, love seats, tables, desks, radiators, entertainment centers, dressers, night stands, bookcases or other household or office furniture, and combinations thereof.

The term floor or surface area generally relates to and is understood to include a ceramic tile floor, a stone floor, a concrete floor, a vinyl floor, a hardwood floor, or carpeted floor, other common floors or flooring, and combinations thereof.

The term adjacent generally relates to and is understood to mean having a common boundary or edge, near or close to but not necessarily touching. The term adjacent is also understood to mean proximate, i.e., very near or next to.

The term loose-laid generally relates to and is understood to mean not permanently attached to the floor, surface, carpet or other material on a floor or surface.

The term pieced together generally relates to and is understood to mean adhered, joined, stapled, nailed, glued, pressed, permanently or semi-permanently attached, and combinations thereof.

In a preferred embodiment, a floor or surface covering includes a single article of a material or multiple pieces of a material joined together that form a single article, in which the floor or surface covering surrounds a moveable or fixed article of furniture, in which the floor or surface covering surrounds the movable or fixed article of furniture on two or three sides of the furniture, and in which the floor or surface covering is positioned in a location that is adjacent to the two or three sides of the furniture.

In a preferred embodiment, the floor or surface covering is a loose-laid article of article of material. The material comprises carpet, carpet tiles, cloth, mats, rugs, textiles, panels, remnants, or combinations thereof. A portion of an underside or entire underside of the floor or surface covering is padded or unpadded.

In a preferred embodiment, the floor or surface covering has an outer perimeter, in which the outer perimeter comprises binding around the entire outer perimeter or a portion thereof.

In a preferred embodiment, the floor or surface covering is positioned on a finished, unfinished, or partially finished floor or floor covering. The floor or surface area may be ceramic tile floor, a stone floor, a concrete floor, a vinyl floor, a hardwood floor, or a carpeted floor.

In a preferred embodiment, the floor or surface covering is a cut-out, pre-cut, pieced together, or sewn together article. The floor or surface covering may be a U-shape, an L-shape, a V-shape, or an open semi-circular shape article.

In a preferred embodiment, the floor or surface covering has a shape that contours to outer dimensions of the two or three sides of the furniture, or has a U-shape article having two 90° angles instead of curves in the inner and outer sides of the U-shape.

In another preferred embodiment, the floor or surface covering surrounds furniture that includes but is not limited to a bed, sofa, chair, love seat, table, desk, radiator, entertainment center, dresser, night stand, bookcase or other household or office furniture.

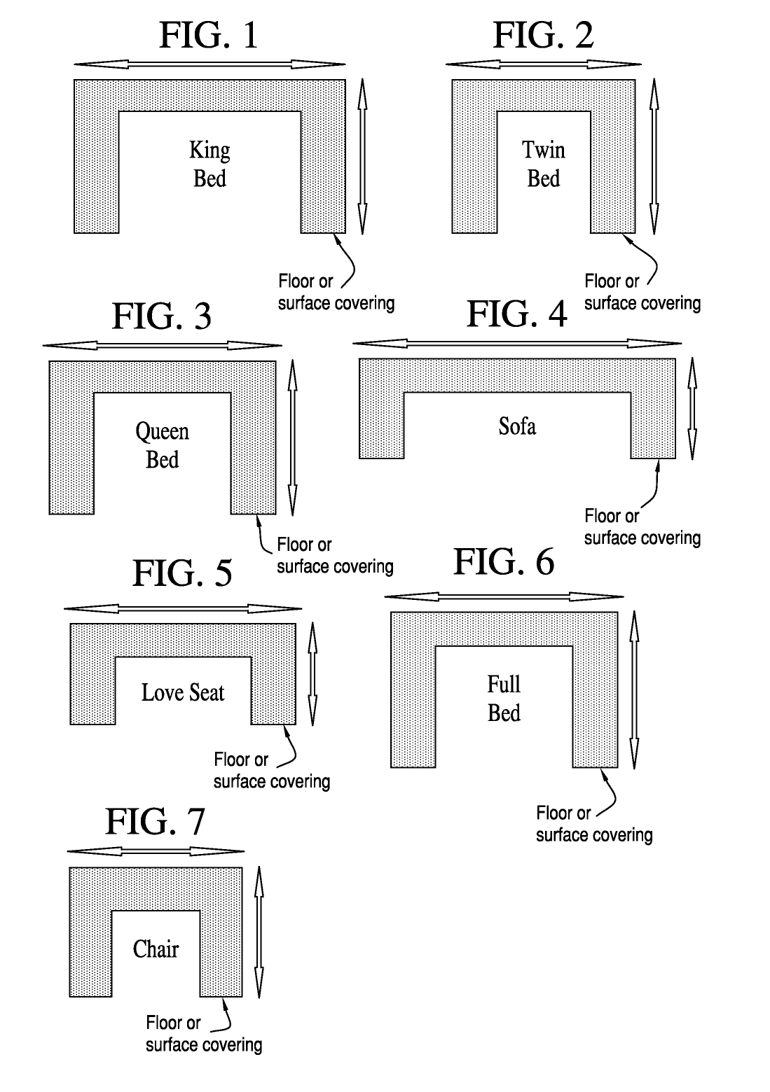

For instance, FIG. 1 illustrates the floor or surface covering surrounding a typical piece of furniture, in this case a king size bed having the standard dimensions of 76″×80″.

In another embodiment, FIGS. 2-7 illustrate the floor or surface covering surrounding other pieces of furniture.

For instance, FIG. 2 illustrates the floor covering surrounding a twin size bed with standard dimensions of 39″×75″, FIG. 3 illustrates the floor covering surrounding a queen size bed with standard dimensions of 60″×80″, FIG. 4 illustrates the floor covering surrounding a sofa, FIG. 5 illustrates the floor or surface covering surrounding a love seat, FIG. 6 illustrates the floor or surface covering surrounding a full size bed with standard dimensions of 54″×75″, and FIG. 7 illustrates the floor or surface covering surrounding a typical mid-size or large chair.

In another preferred embodiment, the floor or surface covering is a carpet or a piece of area carpeting. Carpet or carpeting is generally understood to mean a thick heavy covering for a floor, usually made of woven wool or synthetic fibers.

In a preferred embodiment, the carpet may be a single article of material or multiple pieces of a material joined together that form a single article of material, in which the carpet surrounds a moveable or fixed article of furniture on a floor surface, in which the carpet surrounds the movable or fixed article of furniture on two or three sides of the furniture, and in which the carpet is positioned in a location that is adjacent to the two or three sides of the furniture.

In a preferred embodiment, the carpet is a loose-laid or non-tacked article of material. The carpet has an outer perimeter, in which the outer perimeter comprises binding around the entire outer perimeter or a portion thereof, and a portion of an underside or entire underside of the carpet is padded or unpadded. In addition, the carpet may be a cut-out, pre-cut, pieced together or sewn together article.

In another preferred embodiment, the carpet may be positioned on a finished, unfinished, or partially finished floor or floor covering, in which the floor or surface area is a ceramic tile floor, a stone floor, a concrete floor, a vinyl floor, a hardwood floor, or a carpeted floor.

Obviously, numerous modifications and variations of the disclosure are possible in light of the above disclosure. It is therefore understood that within the scope of the appended claims, the disclosure may be practiced otherwise than as specifically described herein.

What is claimed as new and desired to be protected by Letters Patent of the United States is:

1. A floor or surface covering comprising:
a single article of a material or multiple pieces of a material joined together that form a single article,
wherein the floor or surface covering surrounds a moveable or fixed article of furniture,
wherein the floor or surface covering surrounds the movable or fixed article of furniture on two or three sides of the furniture, and
wherein the floor or surface covering is positioned in a location that is adjacent to the two or three sides of the furniture.

2. The floor or surface covering according to claim 1, wherein the floor or surface covering is a loose-laid article of material.

3. The floor or surface covering according to claim 1, wherein the material comprises carpet, carpet tiles, cloth, mats, rugs, textiles, panels, remnants, or combinations thereof.

4. The floor or surface covering according to claim 1, wherein the floor or surface covering has an outer perimeter, and wherein the outer perimeter comprises binding around the entire outer perimeter or a portion thereof.

5. The floor or surface covering according to claim 1, wherein a portion of an underside or entire underside of the floor or surface covering is padded or unpadded.

6. The floor or surface covering according to claim 1, wherein the floor or surface covering is positioned on a finished, unfinished, or partially finished floor or surface area.

7. The floor or surface covering according to claim 6, wherein the floor or surface area is a ceramic tile floor, a stone floor, a concrete floor, a vinyl floor, a hardwood floor, a carpeted floor, or a combination thereof.

8. The floor or surface covering according to claim 1, wherein the floor or surface covering is a cut-out, pre-cut, pieced together, or sewn together article.

9. The floor or surface covering according to claim 1, wherein the floor or surface covering is a U-shape, an L-shape, a V-shape, or an open semi-circular shape article.

10. The floor or surface covering according to claim 1, wherein the U-shape article has two 90° angles instead of curves in the inner and outer sides of the U-shape.

11. The floor or surface covering according to claim 1, wherein the furniture is a bed, sofa, chair, love seat, table, desk, radiator, entertainment center, dresser, night stand, bookcase, or a combination thereof.

12. A carpet comprising:
a single article of material or multiple pieces of a material joined together that form a single article of material,
wherein the carpet surrounds a moveable or fixed article of furniture on a floor surface,
wherein the carpet surrounds the movable or fixed article of furniture on two or three sides of the furniture, and
wherein the carpet is positioned in a location that is adjacent to the two or three sides of the furniture.

13. The carpet according to claim 12, wherein the carpet is a loose-laid or non-tacked article of material.

14. The floor or surface covering according to claim 12, wherein the floor or surface covering has an outer perimeter, and wherein the outer perimeter comprises binding around the entire outer perimeter or a portion thereof.

15. The carpet according to claim 12, wherein a portion of an underside or entire underside of the carpet is padded or unpadded.

16. The carpet according to claim 12, wherein the carpet is positioned on a finished, unfinished, or partially finished floor or surface area.

17. The carpet according to claim 16, wherein the floor or surface area is a ceramic tile floor, a stone floor, a concrete floor, a vinyl floor, a hardwood floor, a carpeted floor, or a combination thereof.

18. The carpet according to claim 12, wherein the carpet is a cut-out, pre-cut, pieced together, or sewn together article.

19. The carpet according to claim 12, wherein the carpet is a U-shape, an L-shape, a V-shape, or an open semi-circular shape article.

20. The carpet according to claim 12, wherein the U-shape article has two 90° angles instead of curves in the inner and outer sides of the U-shape.
